(19) United States
(12) Patent Application Publication
(10) Pub. No.: US 2007/0030517 A1
(43) Pub. Date: Feb. 8, 2007

(54) Smart wireless dongle

(75) Inventor: Shyam Narayanan, San Diego, CA (US)

Correspondence Address: VAN PELT, YI & JAMES LLP, 10050 N. FOOTHILL BLVD #200, CUPERTINO, CA, 95014, US

(73) Assignee: Staccato Communications, Inc.

(21) Appl. No.: 11/499,246

(22) Filed: Aug. 3, 2006

Related U.S. Application Data
(60) Provisional application No. 60/705,572, filed on Aug. 4, 2005.

(51) Int. Cl. G06F 3/12

(52) U.S. Cl. 358/1.15; 358/302

(57) ABSTRACT

Communicating is disclosed. A communication exchanged between an image source and a print destination is intercepted. The print destination is configured to support a wired Universal Serial Bus (USB) connection between the image source and the print destination and there is no wired USB connection between the image source and the print destination. A communication to inject is generated based at least in part on the intercepted communication. The injected communication is transmitted over a wireless USB connection between the image source and the print destination.

### CROSS REFERENCE TO OTHER APPLICATIONS

This application claims priority to U.S. Provisional Patent Application No. 60/705,572 (Attorney Docket No. AIELP043+) entitled SMART WIRELESS DONGLE filed Aug. 4, 2005 which is incorporated herein by reference for all purposes.

### BACKGROUND OF THE INVENTION

As prices for digital cameras and printers that are capable of printing photographs go down, an increasing number of people are printing photographs at home. To make printing photographs more convenient, some cameras and printers support the PictBridge specification. Using PictBridge, a photograph can be printed directly from a digital camera without requiring a computer. The current PictBridge specification uses a wired connection between the camera and the printer, for example using a Universal Serial Bus (USB) cable that is inserted into the USB ports of the camera and printer. There are some existing techniques for converting a wired connection between a printer and a camera to a wireless connection. However, some aspects of these existing techniques may be unattractive, inefficient, and/or proprietary and hence interoperable. It would be useful to improve upon techniques to convert a wired connection into a wireless connection that is more convenient or otherwise desirable for users or device manufacturers.

### BRIEF DESCRIPTION OF THE DRAWINGS

Various embodiments of the invention are disclosed in the following detailed description and the accompanying drawings.

FIG. 1 is a system diagram illustrating an example of a typical system for printing a digital photograph.

FIG. 2 is a system diagram illustrating an embodiment of a system for printing photographs over a Certified Wireless USB connection.

FIG. 3 is a system diagram illustrating an embodiment of a system for printing photographs over a Certified Wireless USB connection in which a smart dongle is coupled to an image source.

FIG. 4 is a system diagram illustrating an embodiment of layers associated with a smart dongle.

FIG. 5 is a flowchart illustrating an embodiment of a process for establishing a wireless connection and transmitting a photograph to be printed over the wireless connection.

FIG. 6A is a flowchart illustrating an embodiment of a process to store and forward a photograph to be printed.

FIG. 6B is a flowchart illustrating an embodiment of a process for intercepting and injecting communications to accelerate a process to obtain a photograph to be printed.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Communication between an image source and a print destination is disclosed. In some embodiments, an image source is a camera and/or a print destination is a printer. A print destination is configured to support a wired Universal Serial Bus (USB) connection between the image source and the print destination. However, there is no wired USB connection between the image source and the print destination. A communication exchanged between an image source and a print destination is intercepted. In some embodiments, the communication is from the print source and/or the intercepted message is formatted or transmitted under the expectation or assumption that there is a wired connection to the image source. In some embodiments, an intercepted communication is from the image source and/or a wired connection is expected or assumed to exist to the print destination. An injected communication is generated based at least in part on an intercepted communication. The injected communication is transmitted over a wireless USB (e.g., Certified Wireless USB) connection between the image source and the print destination. In some embodiments, intercepting a message, generating a message, and/or transmitting a message is/are performed by a dongle removably coupled to a print destination.

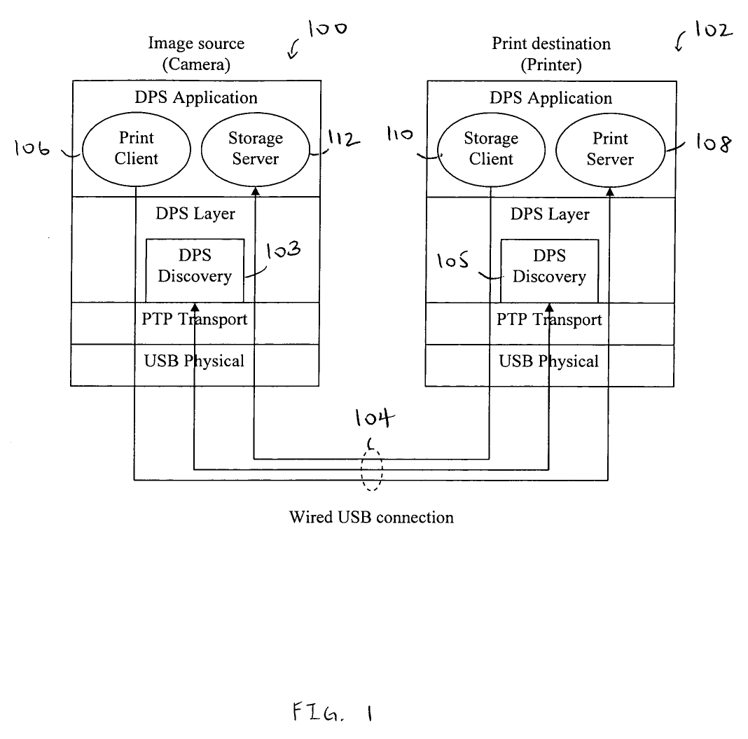

FIG. 1 is a system diagram illustrating an example of a typical system for printing a digital photograph. In the example shown, one or more photographs are stored on image source 100, also referred to as a camera. Camera 100 and print destination 102 (also referred to as a printer) communicate over Wired Universal Serial Bus (USB) connection 104. Three logical connections are illustrated in the example shown. Camera 100 and printer 102 are physically coupled using a USB cable where one end of the cable is inserted into the USB port of camera 100 and the other into the USB port of printer 100.

In this example, camera 100 and printer 102 are configured to support PictBridge, a standard from the Camera and Imaging Products Association (CIPA) that enables a digital photograph to be printed from a camera without requiring the use of a computer. In this example, a wired USB connection is shown, although other connections besides a wired USB connection are permitted under the PictBridge standard.

Digital Photo Solutions (DPS) discovery functions 103 and 105 on camera 100 and printer 102, respectively, are used for discovery (i.e., determining that both camera 100 and printer 102 are PictBridge capable devices). For example, when wired USB connection 104 is established, DPS discovery functions 103 and 105 perform handshaking or otherwise communicate to each other that each device is PictBridge capable.

To print a digital photograph, print client 106 and storage server 112 on camera 100 communicate respectively with printer server 108 and storage client 110 on printer 102. For example, a user may interact with camera 100 to view photographs that are stored on camera 100. Using a camera's display and user interface, a user selects a photograph to print and initiates or triggers a print. Print client 106 communicates with print server 108, signaling a print job. Some identifier or reference of the photograph to be printed is communicated from print client 106 to print server 108. Printer server 108 communicates with storage client 110, causing storage client 110 to obtain the photograph from storage server 112. A reference or identifier of a photograph may be passed from print server 108 to storage client 110. Storage client 110 communicates with storage server 112 (e.g., requesting the photograph to be printed using the identifier or reference) and the photograph is passed to storage client 110 and is printed on printer 102.

It would be attractive to have a wireless connection between camera 100 and printer 102, eliminating the need for a cabled connection. Some solutions use “dongles.” Dongles includes wireless transceivers that communicate over a wireless connection between the two dongles. One dongle may be inserted into a camera 100 and another dongle may be inserted into printer 102 since neither have wireless transceivers. However, existing wireless techniques to convert a wired connection into a wireless connection may be less than optimal. For example, some solutions use proprietary wireless technology that requires the use of dongles that are (e.g., specially) configured to operate as a pair. It would be desirable if a non-proprietary wireless connection (e.g., using some specification or standard) is used where, for example, dongles from different manufacturers are able to be used with each other. Some existing solutions use a non-proprietary wireless connection, but require upgrades to software associated with camera 100 and/or printer 102. Some examples of software that may require upgrades are drivers, firmware, applications, etc. It would be desirable if cameras and/or printers that are configured to use a wired connection could without requiring upgrades to software associated one or more devices in the system.

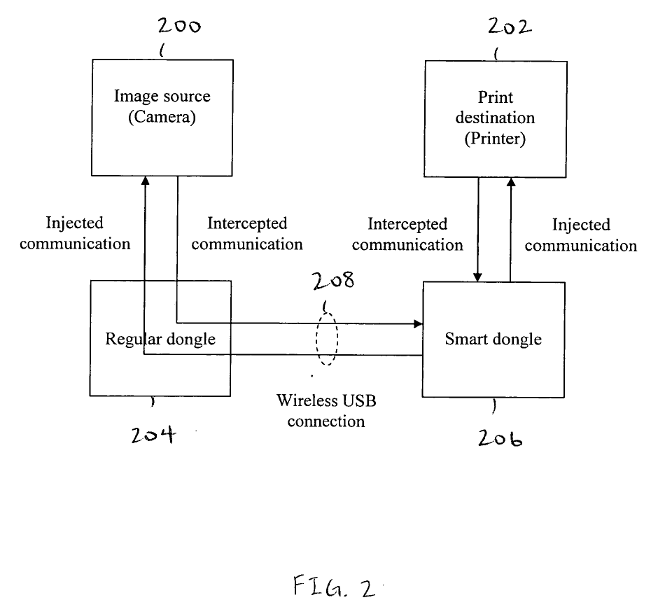

FIG. 2 is a system diagram illustrating an embodiment of a system for printing photographs over a wireless USB connection. In the example shown, camera 200 and printer 202 have the same software or are otherwise configure the same as camera 100 and printer 102 of FIG. 1. That is, drivers, firmware or other software installed on camera 200 and/or printer 202 are not upgraded to support a wireless connection and/or such software may be aware that a wireless connection is used. In this example, camera 200 and printer 202 are configured to support the PictBridge standard to print on printer 202 a photograph stored on camera 200. In some embodiments, a wireless USB connection is a Certified Wireless USB connection.

Dongles (also referred to as wireless adapters) are removably coupled to camera 200 and printer 202. In some embodiments, a dongle is a relatively small, portable device (e.g., a few inches in length) that includes a wireless transceiver. A dongle is removably coupled to a device without wireless capabilities and via the dongle information is exchanged wirelessly using the wireless transceiver included in the dongle. In some applications, a dongle communicates directly with a device with native (i.e., built-in) wireless capabilities. In some applications, a dongle communicates with another dongle that is coupled to a device without wireless capabilities. In this example, regular dongle 204 and smart dongle 206 include wireless transceivers that are configured to support a, for example, Certified Wireless USB connection. Camera 200 is inserted into the USB port of regular dongle 204. Smart dongle 206 is inserted into the USB port (not shown) of printer 202. Using the wireless transceivers included in dongles 204 and 206, communication is exchanged over connection 208.

The Certified Wireless USB specification (defined by the Certified Wireless USB Promoter Group) uses ultra wideband (UWB) technology described in the WiMedia specification. UWB technologies (as opposed to narrowband wireless technologies) use a bandwidth that is very wide. In some embodiments, a Certified Wireless USB host is used that is capable of supporting only one device. In some embodiments, more than one camera or device is supported. Elements of connection 208 in some embodiments conform to the Certified Wireless USB specification (e.g., connection 208 uses WiMedia UWB technology). In some embodiments, other wideband technologies (e.g., besides WiMedia UWB) or narrow band technologies (e.g., WiFi IEEE 802.11, WiMax IEEE 802.16, Bluetooth, etc.) are used.

To enable or otherwise provide a wireless connection without upgrading software on camera 200 and/or printer 202, smart dongle 206 intercepts and injects communications as appropriate exchanged between camera 200 and printer 202. In the example shown, smart dongle 206 is aware that it is being used to transfer a photograph from a camera to a printer and/or may have some knowledge about the PictBridge standard (e.g., a prescribed handshaking or sequence of messages defined by the PictBridge standard). Some communication that is intercepted and/or injected is associated with providing wireless connection 208 without requiring upgrades to software. For example, since printer 202 is expecting a wired connection, the expected response time for transmitted messages is relatively short, for example on the order of 5 seconds. In various embodiments, communications are intercepted and/or injected by smart dongle 206 to delay printer 202 until camera 202 or dongle 204 is ready to establish wireless connection 208; accelerate the exchange of communications exchanged (e.g., smart dongle 206 injects a communication in anticipation of a response or subsequent frame that is triggered by an intercepted communication); and/or obtains a photograph that may be potentially printed prior to any indication from the user to print the photograph. Some embodiments are described in further detail below.

Regular dongle 204 in this example is a standard dongle (i.e., conforms at least the portion or section of a Certified Wireless USB specification that describes wireless adapters to be used with devices that do not have built-in wireless capabilities). Although wireless connection 208 in this example is a point-to-point connection, regular dongle 204 in some applications is able to be used in other connections (e.g., a star topography) and/or with other wireless adapters besides smart dongle 206 (e.g., with another regular dongle that conforms to the same Certified Wireless USB specification as regular dongle 204).

In some embodiments, the system may vary from the example system shown. For example, in some embodiments, camera 200 is a native wireless device. That is, camera 200 in some embodiments includes a wireless transceiver so that regular dongle 204 is not needed. Although some of the examples described herein may show cameras and/or printers without built-in wireless capabilities, the techniques disclosed herein may be used in systems where one device is a native Certified Wireless USB device.

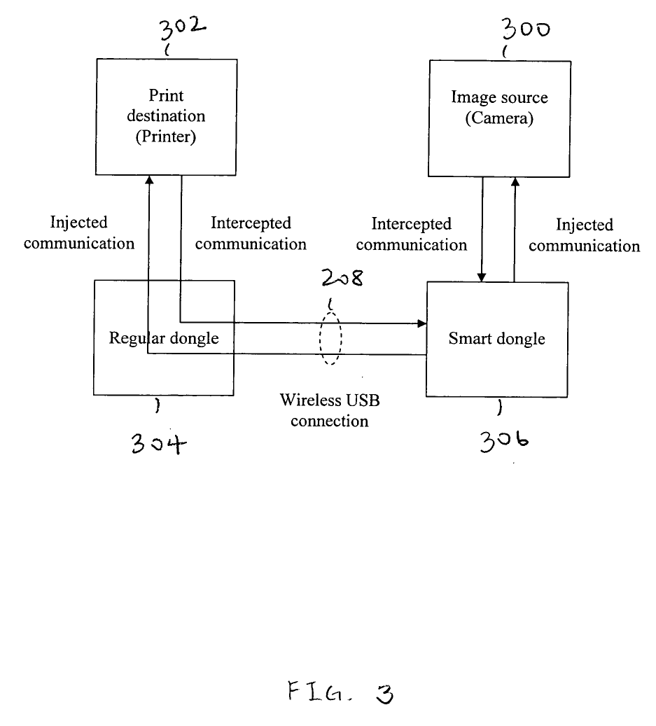

FIG. 3 is a system diagram illustrating an embodiment of a system for printing photographs over a Certified Wireless USB connection in which a smart dongle is coupled to an image source. In the example shown, smart dongle 306 is coupled to camera 300 and a standard dongle (e.g., a Certified Wireless USB host wireless adapter (HWA)) is coupled to printer 302. In this example, the firmware and the functionality associated with smart dongle 306 is somewhat different from the one shown in FIG. 2 that is configured to be coupled to a printer. If needed, in some embodiments the functions described with respect to FIG. 2 are modified to support a particular arrangement or configuration of devices in a system.

Although some of the examples described herein illustrate a system with a camera and a printer, in some embodiments a system that uses a smart dongle includes different devices. For example, other devices such as audio/visual content players, display devices (e.g., televisions, speakers, etc.), scanners, cellular phones, etc. may be used in addition to or as an alternative to a camera or a printer. In some embodiments, the devices in a system support a standard or specification other than PictBridge.

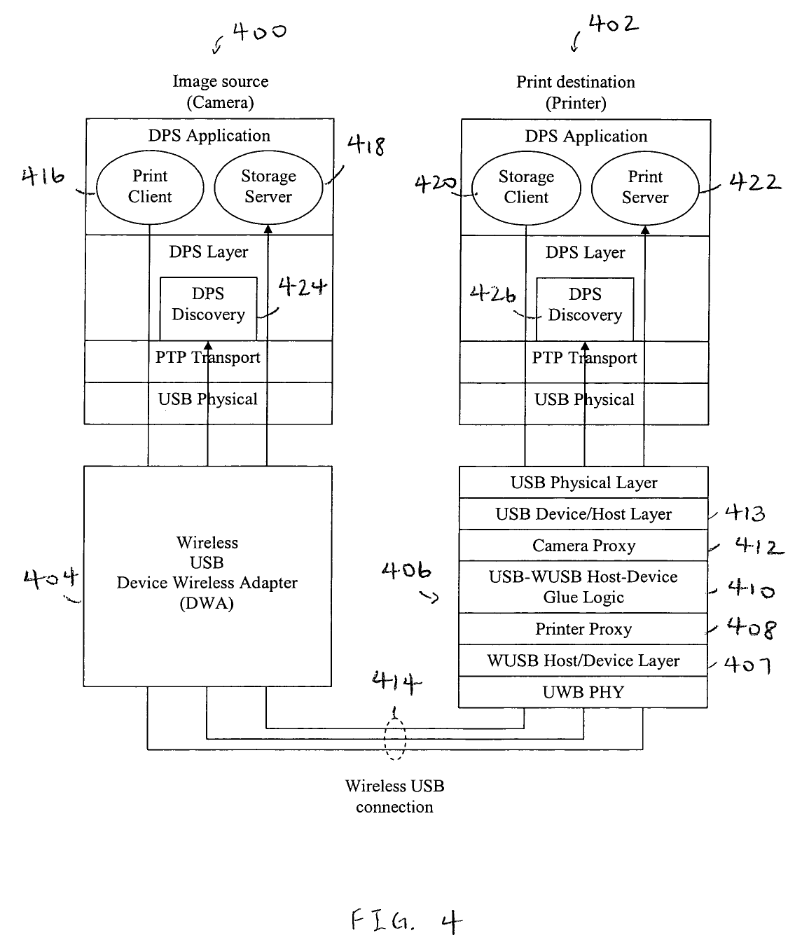

FIG. 4 is a system diagram illustrating an embodiment of layers associated with a smart dongle. In the example shown, printer proxy 408, USB—Certified Wireless USB glue logic 410, and camera proxy 412 intercept and inject communications to support communication over Wireless USB connection 414. In some embodiments, connection 414 is a Certified Wireless USB connection. Using layers 408, 410, and 412, it is not necessary to upgrade software installed on printer 402 and/or camera 400. Printer 402, camera 400, and/or the processes running on them in some embodiments are unaware that the connection being used is a wireless connection.

Camera proxy 412 communicates with processes running on printer 402, although processes running on printer 402 may believe the communications originate from camera 400. Similarly, printer proxy 41408 communicates with processes running on camera 400, although processes running on camera 400 may be unaware that communications it receives are from smart dongle 406 (e.g., rather than printer 402). UWB—Certified Wireless USB host-device glue logic 410 is used Certified Wireless USB coordinate the functioning of 408 and 412 along with the USB device/host layer 413 and WUSB host/device layer 407

In some embodiments, camera proxy 412 communicates with a process running on printer 402 when smart dongle 406 is plugged into a USB port of printer 402. Camera proxy may hold off processes running on printer 402 until camera 400 and/or adapter 404 is available, or may pretend to be a camera and provide requested information when a dongle is first inserted. For example, a USB related process running on printer 402 may attempt to enumerate the inserted smart dongle 406. In some embodiments, smart dongle 406 delays or otherwise holds off enumeration requests. While, for example, camera proxy 412 does this, printer proxy 408 may generate and transmit messages to establish Certified Wireless USB connection with Certified Wireless USB device wireless adapter (DWA) 404. In some embodiments, wireless connection 414 is not established until both WUSB DWA 404 and smart dongle 406 are inserted into camera 400 and printer 402, respectively. Once Certified Wireless USB connection 414 is established, in some embodiments, enumeration is permitted to proceed (e.g., generation and transmission of messages to delay or otherwise hold off enumeration is stopped).

In some embodiments, DPS discovery related communication or messages are intercepted and/or injected by proxies 408 and/or 412. For example, DPS discovery functions 424 and 426 may signal to each other that they are both PictBridge capable. In some embodiments, smart dongle 406 is aware of this DPS discovery related messages or protocols and generates and transmits messages to DPS discovery function 426 running on printer 402. Printer proxy 408 in some embodiments generates and transmits DPS discovery related messages in anticipation of messages that (normally) would be generated by a DPS discovery function. In some embodiments, DPS discovery related settings, types, or capabilities described or otherwise reported by camera proxy 412 to DPS discovery function 426 running on printer 402 are based on default values, a prior value (e.g., from a prior session), or a user specified value (e.g., a user is able to specify using buttons or some user interface of smart dongle 406 a camera's manufacturer and model number which in turn are used to select appropriate settings or values to transmit to DPS discovery function 426).

Alternatively, in some embodiments, DPS discovery is held off or delayed until DPS discovery function 424 running on camera 400 is available to communicate with DPS discovery function 426 running on printer 402. In some embodiments, null packets are used to hold off a process. For example, the dongle NAK'ing the DPS discovery phase of printer 402 till DPS discovery 424 on camera 400 is available.

In some embodiments, layers in a smart dongle vary from the example described. For example, in some embodiments, a single proxy communicates with processes running on printer 402 as well as processes running on camera 400. In some embodiments, a single module performs translation and intercepts and injections communications to/from camera 400 and printer 402.

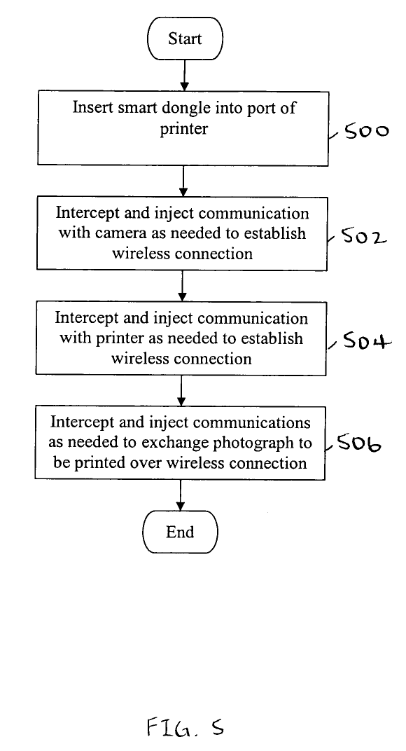

FIG. 5 is a flowchart illustrating an embodiment of a process for establishing a wireless connection and transmitting a photograph to be printed over the wireless connection. In the example shown, the process may be performed by one or more proxies running on a smart dongle. Although this example and other figures may describe the smart dongle being coupled to a printer, on some embodiments the smart dongle is coupled to a camera and the illustrated process is accordingly modified. In some embodiments, a camera is a native wireless device; in other embodiments, a camera does not have built-in wireless capabilities and a dongle (i.e., wireless adapter) is coupled to the camera.

At 500, a smart dongle is inserted into the port of a printer. In some embodiments, the port is a USB port and the printer is configured to support PictBridge. Firmware or other software running on the printer is not upgraded and may be unaware of the wireless connection.

At 502, communication with a camera is intercepted and injected as needed to establish a wireless connection. In some embodiments, step 502 is performed by a proxy configured to communicate with processes running on a camera. Communication with a printer is intercept and injected as needed to establish wireless connection at 504. In some embodiments, steps 502 and 504 overlap. The exact ordering of steps 502 and 504 in some cases depends upon the order in which dongles are inserted into their respective devices, when a camera (and its associated dongle, if any) and a printer (and its associated dongle, if any) are brought into range of one another, etc.

At 506, communications are intercepted and injected as needed to exchange image to be printed over wireless connection. In some embodiments, a store and forward technique is used where a picture is obtained without any indication from the user that that picture will be printed. In some embodiments, communications are injected (e.g., in anticipation of proper or expected responses) once a user has indicated a particular photograph is to be printed. For example, a smart dongle may know that for a given message (e.g., generated by a process running on a camera) there will be a certain response. In some embodiments, a smart dongle generates and transmits that response (e.g., to a processing running on the camera) before a response is actually generated and/or transmitted by its regular source (e.g., from a process running on a printer).

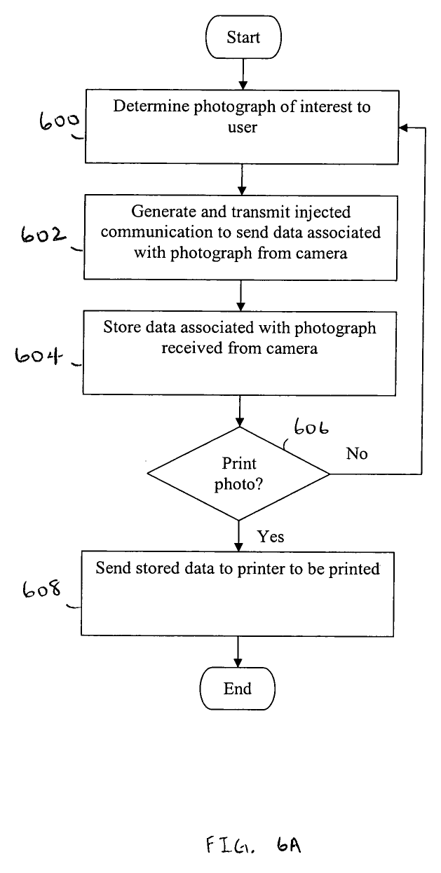

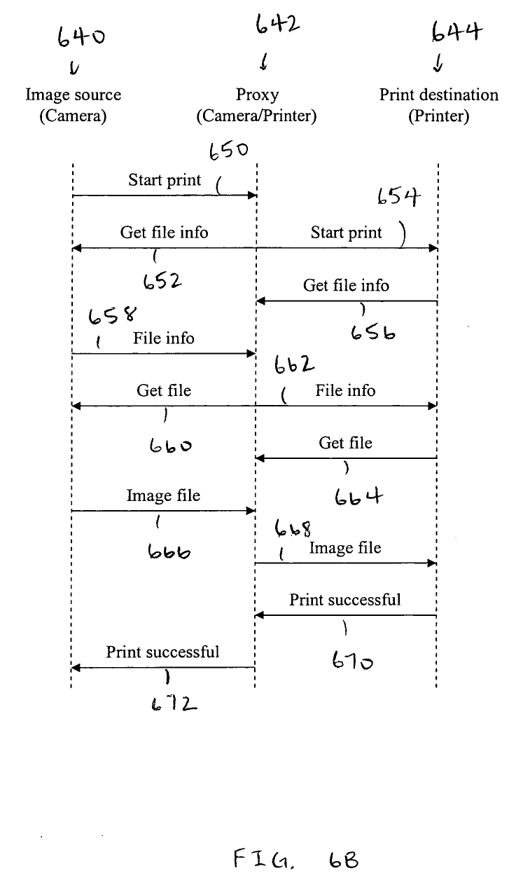

FIG. 6A is a flowchart illustrating an embodiment of a process to store and forward a photograph to be printed. In some embodiments, the illustrated process is used at 506 to obtain a photograph to be printed. In the example shown, the process is performed by one or more proxies running on a smart dongle (e.g., coupled to a printer without built-in wireless capabilities). In the example process, a photograph that may or may not be printed is obtained before there is any indication (e.g., triggered by a user) that the photograph being obtained will actually be printed. Since transferring a photograph over a wireless connection may require a non-trivial amount of time, it may be desirable to anticipate which photograph will be printed next and obtain at least some of photograph data ahead of time.

At 600, a photograph of interest to a user is determined. In some embodiments, a photograph of interest is the photograph that is currently selected by a user (e.g., using the display and user interface of a camera). In some embodiments, a previous print job and/or a sequence of photographs is used in determining a photograph of interest. For example, the user may have printed a particular photograph. The next and previous photographs or a range of photographs before and after the one printed last in a sequence or list of photographs (e.g., based on the time at which the photographs were taken) is determined to be of interest to the user. These are read ahead in anticipation and cached for use. The cache is cleared when the user navigates past the range.

In some embodiments, there is some process or agent running on a camera used in determining a photograph of interest at 600. For example, a process may be running on the camera and may communicate to a proxy what photograph a user currently has selected. The process may generate messages identifying a photograph being viewed, a time at which the user began viewing or selected an image, etc. Any appropriate communication technique (e.g., push versus pull) may be used to transfer this information.

Injected communication is generated and transmitted at 602 to send data associated with a photograph from a camera. For example, a proxy running on a smart dongle may generate a request for the photograph of interest determined at 600. An identifier, such as a descriptor, file names, or other identifier or reference may be included in a request generated by a proxy running on a smart dongle. This communication may be injected in and a receiving process on a camera (e.g., an storage server) may be unaware that the source of the communication is a smart dongle, rather than a process running on the printer (e.g., an storage client).

At 604, data associated with a photograph received from a camera is stored. For example, in some embodiments a smart dongle includes memory that is used to store data received from a camera. In some embodiments, a photograph is larger than the size of a memory included in a smart dongle. In some embodiments, only a portion of a photograph is stored on the smart dongle.

It is decided at 606 whether the photograph will be printed. For example, in some embodiments, if a user advances to or otherwise selects another picture, it is decided at 606 that the photograph will not be printed. In some embodiments, it is decided at 606 that a photograph will be printed when a user triggers a print job.

If a photograph is to be printed, stored data is sent to a printer to be printed at 608. In some embodiments, a proxy on a smart dongle waits to intercept an appropriate communication before providing the stored data. For example, a proxy may wait to intercept a “get file” message (e.g., sent by a storage client running on a printer) before sending back the stored data. The stored data may be encapsulated or formatted as appropriate. Otherwise, if a photograph is not to be printed, a next photograph of interest is determined at 600. In some embodiments, photograph data is discarded or overwritten with data from the next photograph that is obtained.

FIG. 6B is a flowchart illustrating an embodiment of a process for intercepting and injecting communications to accelerate a process to obtain a photograph to be printed. In the example shown, a photograph is not obtained from a camera until a user indicates that a particular photograph will be printed. However, proxy 642 (e.g., running on a smart dongle) is aware to some degree of a prescribed sequence of messages or some other proper or expected procedure to transmit a photograph. For example, a PictBridge camera and a PictBridge printer may exchange a sequence of communications as described in the PictBridge standard. The thin client has some knowledge of this sequence of messages and injects communications without, for example, waiting for a communication to propagate an intended destination (e.g., a client or server running on a one of the devices) and for the response to be generated by that intended destination. This may be implemented in proxy 642 in a variety of ways, for example by using a lookup table of appropriate messages to inject based on an intercepted message. In some embodiments, intercepted messages are passed on to their intended destination so that an intended destination may enter a proper state, for example, associated with printing a photograph.

Start print message 650 is transmitted from a camera 640 to proxy 642 running on a smart dongle. In various embodiments, a proxy comprises one or more layers configured to intercept and inject communications to/from a printer or a camera. Proxy 642 observes that the message intercepted is a start print message, indicating that a user wants to print a photograph.

Start print message 654 is transmitted from proxy 642 to printer 644. This may cause printer 644 and/or software running on printer 644 to enter a proper state associated with initiating a print job (e.g., exiting a power save mode). To accelerate the process of obtaining the photograph to be printed, get file info message 652 is generated by proxy 642 and transmitted to camera 640. Get file info message 652 is transmitted in anticipation of a get file info message that will be generated and transmitted by printer 644. In some embodiments, proxy 642 obtains information from printer 644 ahead of time (if needed) so that when get file info message 652 is generated, it is a duplicate of get file info message 656 which was generated by the printer.

In this example, messages that are shown as adjacent to each other are not necessarily transmitted at the same time. For example, although start print message 654 and get file info message 652 are shown adjacent to each other, the messages are not necessarily transmitted at the same time. Transmission of messages 654 and 652 are not dependent upon each other. Similarly, messages 660 and 662 are not necessarily transmitted at the same time.

In response to receiving start print message 654, printer 644 generates get file info message 656 and transmits it to proxy 642. Since get file info message 652 has already been transmitted to camera 652, get file info message 656 is discarded and is not forwarded to camera 640.

File info message 658 includes file information (e.g., a file descriptor, file location, or file name) associated with a photograph being printed and is passed from camera 640 to proxy 642. File info message 662 is passed from proxy 642 to print destination 644. Similar to message 654, passing message 662 to printer 644 may put printer 644 into a proper state for printing. Get file message 660 is generated by proxy 642 and transmitted to camera 640. Proxy 642 has some degree of knowledge about PictBridge procedure and generates and transmits get file message 660 to accelerate the process of obtaining a photograph.

Get file message 664 is transmitting from printer 644 to proxy 642. Proxy 642 has already transmitted a get file message to camera 640, so get file message 664 is discarded and is not passed to camera 640.

Image file 666 is transmitted from camera 640 to proxy 642. File data for the photograph being printed is included in image file 666. In some embodiments, multiple packets or frames are used to transmit an entire image file. Image file 668 is passed from proxy 642 to printer 644. It is not necessary to wait for all file data to be obtained from image source 640 before initiating transfer of file data to printer 644. In some embodiments, data associated with an image file is passed from proxy 642 to printer 644 before all of an image file is received by the proxy.

Printer 644 passes print successful message 670 to proxy 642. Print successful message 672 is passed from proxy 642 to camera 640.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of communicating, comprising:
intercepting a communication exchanged between an image source and a print destination, wherein the print destination is configured to support a wired Universal Serial Bus (USB) connection between the image source and the print destination and there is no wired USB connection between the image source and the print destination;
generating a communication to inject based at least in part on the intercepted communication; and
transmitting the injected communication over a wireless USB connection between the image source and the print destination.

2. A method as recited in claim 1, wherein software associated with the print destination and/or a camera source is/are not updated to support a wireless connection.

3. A method as recited in claim 1, wherein the wireless USB connection is associated with ultra wideband (UWB).

4. A method as recited in claim 1, wherein the image source and the print destination are configured to support PictBridge.

5. A method as recited in claim 1, wherein the method is performed by a dongle that is removably coupled to either the image source or the print destination.

6. A method as recited in claim 1, wherein:
a first dongle is removably coupled to the image source and a second dongle is removably coupled to the print destination; and
the method is performed by either the first dongle or the second dongle, and the other dongle is configured to support a specification associated with wireless adaptation.

7. A method as recited in claim 1, wherein:
the method is performed by a dongle that is removably coupled to either the image source or the print destination; and
the method further comprises detecting the other device that the dongle is not removably coupled to.

8. A method as recited in claim 1, wherein generating includes:
evaluating the intercepted communication, wherein the intercepted communication is associated with PictBridge; and
determining a communication to inject based at least in part on the intercepted communication and proper procedure(s) associated with PictBridge.

9. A method as recited in claim 1, wherein the injected communication includes a camera type.

10. A method as recited in claim 1, wherein the injected communication includes a default camera type.

11. A method as recited in claim 1, wherein the injected communication includes a camera type associated with a previous session.

12. A method as recited in claim 1, wherein the injected communication is associated with delaying a process running on the print destination until the wireless USB connection is established.

13. A method as recited in claim 1, wherein the injected communication is associated with DPS discovery.

14. A method as recited in claim 1, wherein the injected communication is associated with obtaining a photograph from the image source.

15. A method as recited in claim 1 further comprising:
receiving, from the image source over the wireless USB connection, data associated with a photograph, wherein receiving the data associated with the photograph begins prior to an indication from a user that the photograph is to be printed; and
storing the received data associated with the photograph.

16. A method as recited in claim 1 further comprising:
receiving, from the image source over the wireless USB connection, data associated with a photograph, wherein receiving the data associated with the photograph begins prior to an indication from a user that the photograph is to be printed;
storing the received data; and
passing the stored data to the print destination.

17. A system for communicating, comprising:
an interceptor configured to intercept a communication exchanged between an image source and a print destination, wherein the print destination is configured to support a wired Universal Serial Bus (USB) connection between the image source and the print destination and there is no wired USB connection between the image source and the print destination;
a processor configured to generate a communication to inject based at least in part on the intercepted communication; and
a transmitter configured to transmit the injected communication over a wireless USB connection between the image source and the print destination.

18. A computer program product for communicating, the computer program product being embodied in a computer readable medium and comprising computer instructions for:
intercepting a communication exchanged between an image source and a print destination, wherein the print destination is configured to support a wired Universal Serial Bus (USB) connection between the image source and the print destination and there is no wired USB connection between the image source and the print destination;
generating a communication to inject based at least in part on the intercepted communication; and
transmitting the injected communication over a wireless USB connection between the image source and the print destination.
